(19) United States
(12) Patent Application Publication
(10) Pub. No.: US 2009/0261489 A1
(43) Pub. Date: Oct. 22, 2009

(54) METHOD FOR MAKING LENSES

(75) Inventor: SHAN-FU HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/327,595

(22) Filed: Dec. 3, 2008

(30) Foreign Application Priority Data
Apr. 21, 2008 (CN) 200810301218.5

(51) Int. Cl. B29D 11/00

(52) U.S. Cl. 264/1.32

(57) ABSTRACT

A method for making a plurality of lenses, is provided. Each of the lenses has an optical structure on at least one side thereof. The method includes steps of: providing a lens material sheet having a first surface and an opposing second surface; providing a press-molding roller, the press-molding roller having a circumferential surface and a plurality of molding structures formed thereon, the molding structures having molding surfaces to form the optical structures of the lenses; press-molding one of the first and second surfaces of the lens material sheet by applying and rolling the press-molding roller thereon, thereby forming a plurality of the optical structures on the lens material sheet; and dicing the lens material sheet into a plurality of the lenses each having one of the optical structures on the at least one side thereof.

### BACKGROUND

1. Technical Field

The present invention relates to a method for making a plurality of lenses.

2. Description of Related Art

Lenses, are transparent and usually have concave or convex optical structures formed at opposite sides thereof. The surfaces of the optical structures are called optical surfaces.

Injection molding has been widely used for making large quantities of the lenses. However, only a few lenses can be made in an injection mold apparatus at a time, such that a high efficiency cannot be obtained.

What is needed, therefore, is a method for making a plurality of lenses, which can overcome the above shortcomings.

### SUMMARY

A method for making a plurality of lenses, is provided. Each of the lenses has an optical structure on at least one side thereof. The method includes steps of: providing a lens material sheet having a first surface and an opposing second surface; providing a press-molding roller, the press-molding roller having a circumferential surface and a plurality of molding structures formed thereon, the molding structures having molding surfaces to form the optical structures of the lenses; press-molding at least one of the first and second surfaces of the lens material sheet by applying and rolling the press-molding roller thereon, thereby forming a plurality of the optical structures on the lens material sheet; and dicing the lens material sheet into a plurality of the lenses each having one of the optical structures on the at least one side thereof.

Other advantages and novel features of the method will become more apparent from the following detailed description of embodiment when taken in conjunction with the accompanying drawings.

### BRIEF DESCRIPTION OF THE DRAWINGS

Many aspects of present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a schematic view of a first embodiment of present method.

FIG. 2 is a schematic view of a second embodiment of present method.

FIG. 3 is a cut-away view of FIG. 2 taken along the line III-III.

### DETAILED DESCRIPTION OF THE EMBODIMENTS

Embodiments of the present method will now be described in detail below and with reference to the drawings.

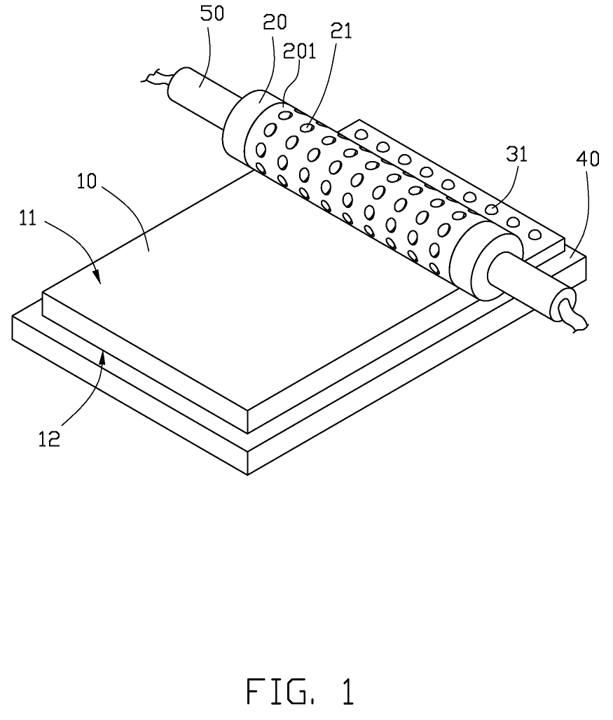

Referring to FIG. 1, a method for making a plurality of lenses in accordance with a first embodiment, is provided. Each of the lenses has an optical structure 31 on one side thereof. The method mainly includes steps of:

providing a lens material sheet 10 having a first surface 11 and an opposing second surface 12;

providing a press-molding roller 20, the press-molding roller 20 having a circumferential surface 201 and a plurality of molding structures 21 formed thereon, the molding structures 21 having molding surfaces to form the optical structures 31 of the lenses;

press-molding the first surface 11 of the lens material sheet 10 by applying and rolling the press-molding roller 20 thereon, thereby forming a plurality of the optical structures 31 on the lens material sheet 10; and

dicing the lens material sheet 10 into a plurality of the lenses each having one of the optical structures 31 on the side thereof.

The lens material is preferably a thermoplastic material. The thermoplastic material can be a polymer, such as Polycarbonate (PC) and Polymethylmecrylate (PMMA).

The press-molding roller 20 is made of a thermally conductive metallic material. A thermocouple (not shown) can be inserted in the press-molding roller 20 to heat up the press-molding roller 20 during the press-molding step. The press-molding roller 20 is connected to a driving unit 50 to drive the press-molding roller 20 to roll on the first surface 11 of the lens material sheet 10.

In the present embodiment, the optical structures 31 are convex structures, such that the molding structures 21 on the press-molding roller 20 are cavities. In this way, the molding structures 21 correspond to the optical structures 31 of the lenses.

The lens material sheet 10 can be disposed on a base 40 during the press-molding step. Furthermore, a UV light is applied to the lens material sheet 10 during the press-molding step, thereby solidifying the optical structures 31.

According to the above method, a high efficiency for making a plurality of lenses can be obtained.

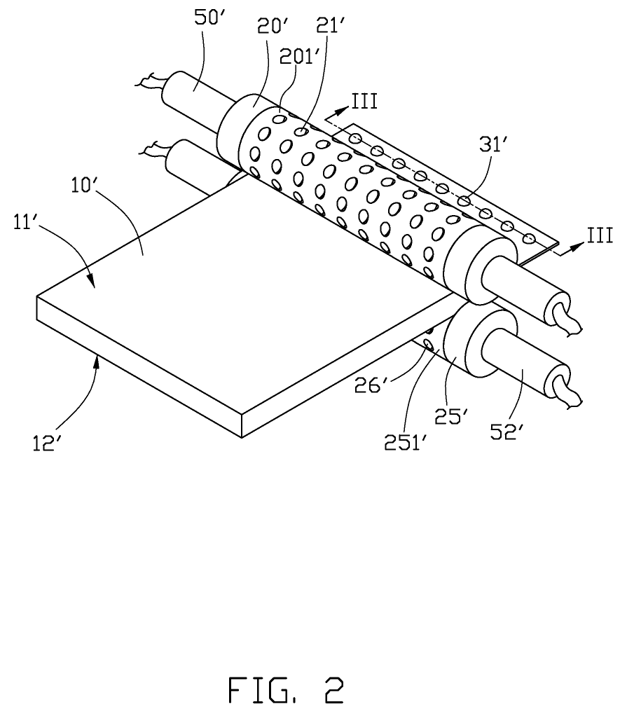

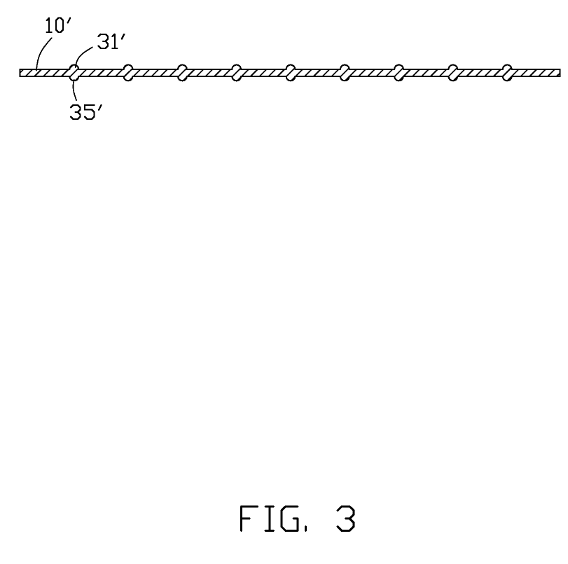

Referring to FIGS. 2 and 3, a method for making a plurality of lenses in accordance with a second embodiment, is provided. Each of the lenses has a first optical structure 31′ and a second optical structure 32′ on opposite sides thereof. The method mainly includes steps of:

providing a lens material sheet 10′ having a first surface 11′ and a second surface 12′ on opposite sides thereof;

providing a first press-molding roller 20′ and a second press-molding roller 25′, the first press-molding roller 20′ having a first circumferential surface 201′ and a plurality of first molding structures 21′ formed thereon to correspond to the first optical structures 31′ of the lenses, the second press-molding roller 25′ having a second circumferential surface 251′ and a plurality of second molding structures 26′ formed thereon to correspond to the second optical structures 35′ of the lenses;

press-molding the first surface 11′ of the lens material sheet 10′ by applying and rolling the first press-molding roller 20′ thereon, thereby forming a plurality of the first optical structures 31′ on the first surface 11′ of the lens material sheet 10′;

press-molding the second surface 12′ of the lens material sheet 10′ by applying and rolling the second press-molding roller 25′ thereon, thereby forming a plurality of the second optical structures 35′ on the second surface 12′ of the lens material sheet 10′; and

dicing the lens material sheet 10′ into a plurality of the lenses each having one of the first optical structures 31′ and one of the second optical structures 35′ on the opposite sides thereof.

In the present embodiment, the first optical structures 31′ and the second optical structures 35′ both are convex structures, such that the first molding structures 21′ on the first press-molding roller 20′ and the second molding structures 26′ on the second press-molding roller 25′ are cavities. The first press-molding roller 20′ is connected to a first driving unit 50′ to drive the first press-molding roller 20′ to roll, and the second press-molding roller 25′ is connected to a second driving unit 52′ to drive the second press-molding roller 25′ to roll. The two press-molding steps are performed simultaneously.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A method for making a plurality of lenses, each of the lenses having an optical structure on at least one side thereof, the method comprising:
providing a lens material sheet having a first surface and an opposing second surface;
providing a press-molding roller, the press-molding roller having a circumferential surface and a plurality of molding structures formed thereon, the molding structures having molding surfaces to form the optical structures of the lenses;
press-molding at least one of the first and second surfaces of the lens material sheet by applying and rolling the press-molding roller thereon, thereby forming a plurality of the optical structures on the lens material sheet; and
dicing the lens material sheet into a plurality of the lenses each having one of the optical structures on the at least one side thereof.

2. The method of claim 1, wherein the lens material is thermoplastic material.

3. The method of claim 1, wherein the press-molding roller is made of a thermally conductive metallic material.

4. The method of claim 3, wherein the press-molding roller is heated up during the press-molding step.

5. The method of claim 1, wherein a UV light is applied to the lens material sheet during the press-molding step to solidify the optical structures.

6. A method for making a plurality of lenses, each of the lenses having a first optical structure and a second optical structure on opposite sides thereof, the method comprising:
providing a lens material sheet having a first surface and an opposing second surface;
providing a first press-molding roller and a second press-molding roller, the first press-molding roller having a first circumferential surface and a plurality of first molding structures formed thereon, the first molding structures having first molding surfaces to form the first optical structures of the lenses, the second press-molding roller having a second circumferential surface and a plurality of second molding structures formed thereon, the second molding structures having second molding surfaces to form the second optical structures of the lenses;
press-molding the first surface of the lens material sheet by applying and rolling the first press-molding roller thereon, thereby forming a plurality of the first optical structures on the first surface of the single body of lens material;
press-molding the second surface of the lens material sheet by applying and rolling the second press-molding roller thereon, thereby forming a plurality of the second optical structures on the second surface of the single body of lens material; and
dicing the lens material sheet into a plurality of the lenses each having one of the first optical structures and one of the second optical structures at the opposite sides thereof.

7. The method of claim 6, wherein the lens material is thermoplastic material.

8. The method of claim 6, wherein the first and second press-molding rollers are made of a thermally conductive metallic material.

9. The method of claim 8, wherein the first and second press-molding rollers are heated up during the press-molding steps.

10. The method of claim 6, wherein a UV light is applied to the lens material sheet during the press-molding steps to solidify the first and second optical structures.

11. The method of claim 6, wherein the press-molding steps are performed simultaneously.
